(19) United States
(12) Patent Application Publication
(10) Pub. No.: US 2024/0315896 A1
(43) Pub. Date: Sep. 26, 2024

(54) Patient Transport Apparatus With Linkage For Articulable Footrest

(71) Applicant: Stryker Corporation, Kalamazoo, MI (US)

(72) Inventors: Shawn Trimble, Portage, MI (US); Christopher Gentile, Sturgis, MI (US)

(73) Assignee: Stryker Corporation, Kalamazoo, MI (US)

(21) Appl. No.: 18/570,405

(22) PCT Filed: Jun. 27, 2022
(86) PCT No.: PCT/US2022/035053

§ 371 Date: Dec. 14, 2023

Related U.S. Application Data
(60) Provisional application No. 63/289,213, filed on Dec. 14, 2021.

(51) Int. Cl. A61G 5/00; A61G 1/017; A61G 1/02; A61G 5/12

(52) U.S. Cl. CPC A61G 5/006; A61G 1/017; A61G 5/127; A61G 5/128; A61G 1/02

(57) ABSTRACT

A patient transport apparatus for patients. The patient transport apparatus comprises a litter including a front assembly. The patient transport apparatus further comprises a footrest assembly operatively attached to the front assembly. The footrest assembly includes a footrest deck section and a linkage assembly operatively attached to and extending between the front portion of the front assembly and the footrest assembly to guide movement of the footrest assembly relative to the front assembly between a stowed position and a deployed position.

### CROSS-REFERENCE TO RELATED APPLICATIONS

The subject patent application claims priority to, and all the benefits of, U.S. Provisional Patent Application No. 63/289,213, filed on Dec. 14, 2021, the entire contents of which are incorporated by reference herein.

### BACKGROUND

Patient support systems facilitate care of patients in a health care setting. Patient support systems comprise patient transport apparatuses such as, for example, hospital beds, stretchers, cots, tables, wheelchairs, chairs, stair chairs, and the like. Many conventional patient transport apparatuses, such as for example cots, generally include a base arranged for movement about floor surfaces, and a litter upon which a patient can be positioned or otherwise supported. Here, one or types of lift mechanisms may be employed to facilitate adjusting a vertical position of the litter relative to the base to, among other things, promote patient care, load the patient transport apparatus into an ambulance, and the like.

Conventional cots may employ one or more articulable deck sections arranged to define a patient support surface that can be adjusted to support the patient between different patient positions. For example, cots may employ an adjustable backrest or fowler deck section that can be adjusted to support the patient between a supine position, a fowler's position, and one or more other patient positions. In some cots, additional sections such a leg section, a seat section, and/or other sections may be provided to facilitate adjusting the patient support surface to other patient positions, such as a gatch position. In some types of patient transport apparatuses, such as those realized as stair chair (also referred to as “evacuation chairs”), foot rests may be employed to support a patient's feet.

While patient transport apparatuses have generally performed well for their intended purpose, there remains a need in the art for patient support surfaces that can be adjusted to support patients in a number of different patient positions to improve patient care during transport.

### SUMMARY

The present disclosure includes a patient support apparatus including a seat assembly having a front end and a rear end. The apparatus also includes a front assembly having a bottom end including a wheel for contacting a ground surface and a top end operatively attached to the front end of the seat assembly. The front assembly is configured for movement between a plurality of front assembly positions including a front assembly chair position and a front assembly loft position. The apparatus also includes a footrest assembly. The footrest assembly includes a footrest mount operatively attached to the bottom end of the front assembly, a footrest frame having a footrest front end and a footrest back end operatively attached to the footrest mount, and a linkage assembly extending between the seat assembly and the footrest mount to coordinate movement of the footrest mount relative to the seat assembly as the front assembly moves between the plurality of front assembly positions.

The linkage assembly may include a four-bar linkage assembly having a first pair of links and a second pair of links extending between the front end of the seat assembly and the footrest mount. The first pair of links and the second pair of links may be arranged to guide the footrest mount along a pre-determined motion profile as the front assembly moves between the plurality of front assembly positions.

The footrest frame may be configured for movement relative to the footrest mount between a plurality of footrest frame positions including a footrest deployed position where the footrest frame is arranged to support feet of a patient, and a footrest stowed position where the footrest frame is substantially parallel to the front assembly.

The patient support apparatus may further include a leg support arranged for pivoting movement about a support axis disposed adjacent to the front end of the seat assembly between a plurality of leg support positions including a leg support deployed position where the leg support is substantially parallel with the seat assembly to support at least one leg of a patient in an elevated position, and a leg support stowed position where the leg support is substantially parallel with the front assembly. In some configurations, the leg support is a first leg support and arranged on a first lateral side of the patient support apparatus. Accordingly, the patient support apparatus may further include a second leg support arranged for pivoting movement about the support axis between a plurality of leg support positions including a second leg support deployed position where the second leg support is substantially parallel with the seat assembly to support a leg of a patient in an elevated position, and a second leg support stowed position where the second leg support is substantially parallel with the front assembly.

### BRIEF DESCRIPTION OF THE DRAWINGS

Advantages of the present disclosure will be readily appreciated as the same becomes better understood by reference to the following detailed description when considered in connection with the accompanying drawings.

FIG. 1A is a perspective view of a patient transport apparatus of a patient support system of the present disclosure, shown with the patient transport apparatus operating in an undocked mode with a base having stabilizers arranged in a deployed configuration to brace the base against floor surfaces for loading a litter, the litter shown positioned adjacent to the base and arranged in a chair configuration.

FIG. 1B is another perspective view of the patient transport apparatus of FIG. 1A, shown with the patient transport apparatus operating in a docked mode with the litter secured to the base and with the stabilizers arranged in a retracted configuration.

FIG. 2 is a schematic view of a control system of the patient transport apparatus of FIGS. 1A-1B.

FIG. 3A shows a front perspective view of the litter of the patient transport apparatus in a chair configuration and including a footrest assembly.

FIG. 3B shows a side view of the patient support apparatus of FIG. 3A.

FIG. 4A shows a front perspective view of the litter of the patient transport apparatus in an intermediate configuration and including the footrest assembly.

FIG. 4B shows a side view of the patient support apparatus of FIG. 4A.

FIG. 5A shows a front perspective view of the litter of the patient transport apparatus in a loft configuration and including the footrest assembly.

FIG. 5B shows a side view of the patient support apparatus of FIG. 5A.

FIG. 6 shows a partial front perspective view of the litter including the footrest assembly.

FIG. 7A shows a partial front perspective view of the litter of the patient transport apparatus in including the footrest assembly having a footrest frame in a deployed position and a lock member in a locked state.

FIG. 7B shows a side view of the patient support apparatus of FIG. 7A.

FIG. 8A shows a partial front perspective view of the litter of the patient transport apparatus in including the footrest assembly having a footrest frame in the deployed position and the lock member in an unlocked state.

FIG. 8B shows a side view of the patient support apparatus of FIG. 8A.

FIG. 9A shows a partial front perspective view of the litter of the patient transport apparatus in including the footrest assembly having a footrest frame in a stowed position.

FIG. 9B shows a side view of the patient support apparatus of FIG. 9A.

FIG. 10A shows a front perspective view of the litter of the patient transport apparatus including a leg support in a stowed position.

FIG. 10B shows a side view of the patient transport apparatus of FIG. 10A including a latch.

FIG. 10C shows an enlarged view of the patient transport apparatus of FIG. 10A including the latch.

FIG. 11A shows a front perspective view of the litter of the patient transport apparatus including a leg support in an intermediate position.

FIG. 11B shows a side view of the patient transport apparatus of FIG. 11A including a latch.

FIG. 11C shows an enlarged view of the patient transport apparatus of FIG. 11A including the latch.

FIG. 12A shows a front perspective view of the litter of the patient transport apparatus including a leg support in a deployed position.

FIG. 12B shows a side view of the patient transport apparatus of FIG. 12A including a latch.

FIG. 12C shows an enlarged view of the patient transport apparatus of FIG. 12A including the latch.

FIGS. 13A-13C show perspective views of the litter of the patient transport apparatus including a first and a second leg support that are each movable independently between a stowed position and a deployed position.

### DETAILED DESCRIPTION

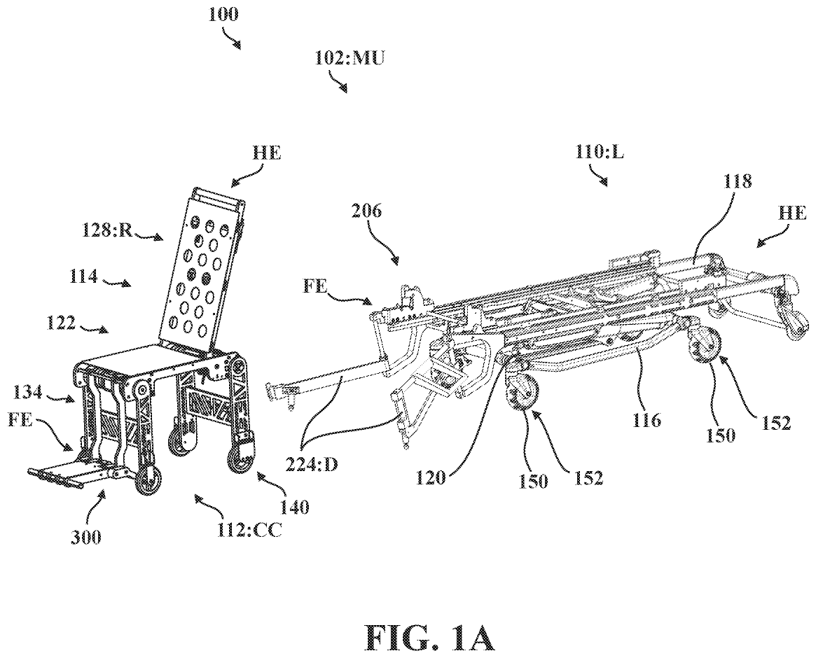

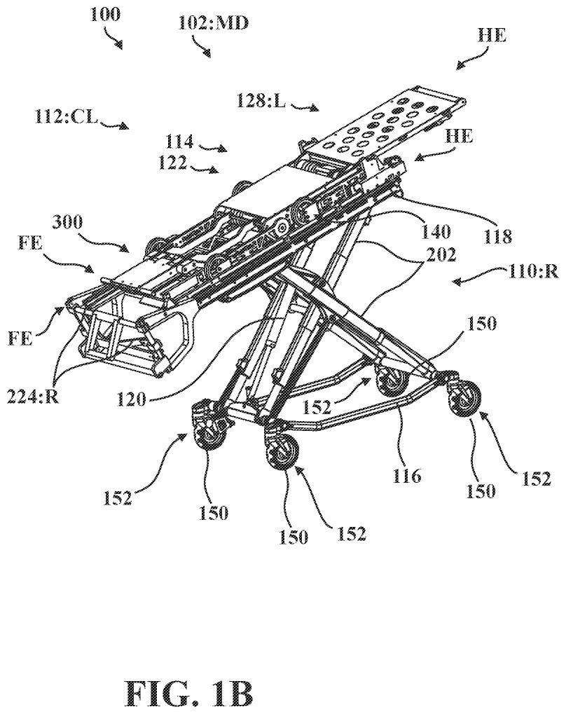

Referring to FIGS. 1A-1B, portions of a patient support system 100 are shown including a patient transport apparatus 102 for supporting a patient in a health care setting according to aspects of the present disclosure. As will be appreciated from the subsequent description below, while the illustrated versions of the patient transport apparatus 102 described herein are configured as adjustable cots and stair chairs for transporting patients, the patient transport apparatus 102 may comprise a hospital bed, a stretcher, a table, a wheelchair, a chair, or a similar apparatus utilized in the care of a patient. The version of the patient transport apparatus 102 shown in FIGS. 1A-1B generally comprises abase 110 and a litter 112. The litter 112 defines or otherwise comprises a patient support surface 114 to support a patient.

In some versions, the patient transport apparatus 102 may comprise a reconfigurable patient support as described in U.S. Pat. No. 9,486,373, which is hereby incorporated by reference in its entirety. In some versions, the patient transport apparatus 102 may comprise a reconfigurable transport apparatus as described in U.S. Pat. No. 9,510,981, which is hereby incorporated by reference in its entirety. In some versions, the patient transport apparatus 102 may comprise a person support apparatus system as described in U.S. Patent Application Publication No. 2018/0028383, which is hereby incorporated by reference in its entirety. In some versions, the patient transport apparatus 102 may comprise a patient transfer apparatus with integrated tracks as described in U.S. patent application Ser. No. 15/854,943, which is hereby incorporated by reference in its entirety. In some versions, the patient transport apparatus 102 may comprise a variable speed patient transfer apparatus as described in U.S. patent application Ser. No. 15/854,199, which is hereby incorporated by reference in its entirety. In some versions, the patient transport apparatus 102 may comprise a patient transfer apparatus as described in U.S. patent application Ser. No. 15/855,161, which is hereby incorporated by reference in its entirety. In some versions, the patient transport apparatus 102 may comprise an ambulance cot as described in U.S. Pat. No. 7,398,571, which is hereby incorporated by reference in its entirety.

With continued reference to FIGS. 1A-1B, the base 110 and litter 112 each have a head end HE and a foot end FE corresponding to designated placement of the patient's head and feet on the patient transport apparatus 102. In FIG. 1A, the litter 112 is shown separated from the base 110; as is described in greater detail below, the base 110 is configured to removably receive and support the litter 112 in certain situations. Put differently, in the illustrated version, the litter 112 is configured for releasable attachment to the base 110. The base 110 generally includes abase frame 116, an intermediate frame 118, and abase lift device 120. The intermediate frame 118 is spaced above the base frame 116 and is moved relative to the base frame 116 via the base lift device 120 as described in greater detail below. Although not illustrated in detail in the drawings, a mattress (or sections thereof) may be disposed on or integral with the litter 112. In such circumstances, the mattress comprises or otherwise defines a secondary patient support surface 114 upon which the patient is supported.

In the illustrated versions, the litter 112 employs a plurality of assemblies, some of which are capable of being articulated relative to others in various ways and under certain operating conditions to adjust the patient support surface 114 and to facilitate docking to and undocking from the base 110. In the illustrated version, the litter 112 generally includes a seat assembly 122 with a seat frame 124 and a seat section 126, a fowler assembly 128 with a fowler frame 130 and a fowler section 132, a front assembly 134 with a front frame 136, a rear assembly 140 with a rear frame 142. Each of the assemblies 122, 128, 134, 140 introduced above will be described in greater detail below.

In the illustrated versions, the fowler assembly 128 pivots relative to the seat assembly 122 about a fowler axis XW, the front assembly 134 pivots relative to the seat assembly 122 about a front axis XF, and the rear assembly 140 pivots relative to the seat assembly 122 about a rear axis XR. In the illustrated version, the seat section 126, and the fowler section 132 each provide support to the patient and, thus, generally cooperate to define the patient support surface 114. It will be appreciated that the fowler section 132 may pivot relative to the seat section 126, or may articulate relative to the seat section 126 in any manner. For instance, the fowler section 132 may pivot and translate relative to the seat section 126 in some configurations.

Caregiver interfaces 148, such as handles, help facilitate movement of the patient transport apparatus 102 over floor or ground surfaces. Here, caregiver interfaces 148 may be coupled to the fowler assembly 128, the front assembly 134 (not shown), the intermediate frame 118, and the like. Additional caregiver interfaces 148 may be integrated into other components of the patient transport apparatus 102. The caregiver interfaces 148 are graspable by the caregiver to manipulate the patient transport apparatus 102 for movement.

Base wheels 150 are coupled to the base frame 116 to facilitate transport over floor surfaces. The base wheels 150 are arranged in each of four quadrants of the base 110 adjacent to corners of the base frame 116. In the illustrated versions, the base wheels 150 are caster wheels, which are able to rotate and swivel relative to the base frame 116 during transport. Each of the base wheels 150 forms part of a base caster assembly 152. Each base caster assembly 152 is mounted to the base frame 116. It should be understood that various configurations of base caster assemblies 152 are contemplated. In addition, in some configurations, the base wheels 150 are not caster wheels and may be non-steerable, steerable, non-powered, powered, or combinations thereof. Additional base wheels 150 are also contemplated. For example, the patient transport apparatus 102 may comprise four non-powered, non-steerable wheels, along with one or more powered wheels. In some cases, the patient transport apparatus 102 may not include any wheels. In other configurations, one or more auxiliary wheels (powered or non-powered), which are movable between stowed positions and deployed positions, may be coupled to the base frame 116. In some cases, when these auxiliary wheels are located between caster assemblies and contact the floor surface FS in the deployed position, they cause two of the base caster assemblies 152 to be lifted off the floor surface thereby shortening a wheelbase of the patient transport apparatus 102. A fifth wheel may also be arranged substantially in a center of the base 110. Other configurations are contemplated.

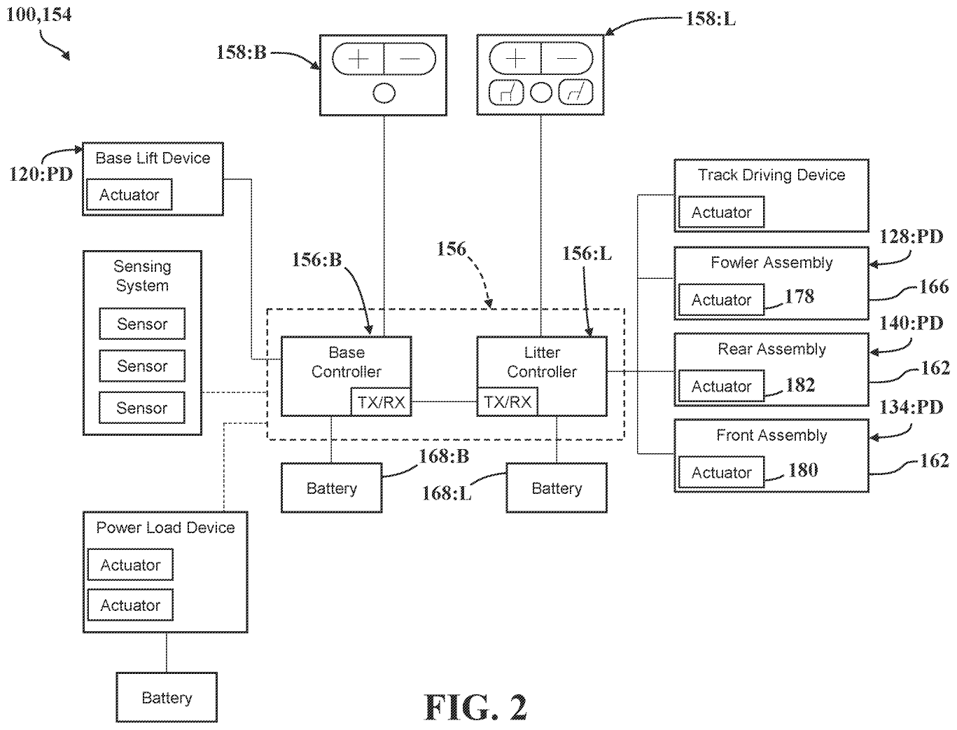

Referring now to FIG. 2, a control system 154 of the patient transport apparatus 102 is shown schematically. It should be noted that in many of the drawings described herein, certain components of the patient transport apparatus 102 have been omitted from view for convenience of description and ease of illustration. The control system 154 generally comprises one or more powered devices PD operated by a base controller 156B and/or a litter controller 156L (collectively referred to herein as “controller 156”) in response to actuation of a base user interface 158B and/or a litter user interface 158L (collectively referred to herein as “user interface 158”) in response to state signals received from a sensing system. Each of these components will be described in greater detail below.

With continued reference to FIG. 2, each of the one or more powered devices PD of the control system 154 is configured to perform one or more predetermined functions. To this end, the powered devices PD employ one or more components that utilize electricity in order to perform functions. One or more powered devices PD of the patient support system 100 and/or the patient transport apparatus 102 may comprise powered adjustment devices, such as a power load device for loading the patient transport apparatus 102 into a cargo area of an ambulance (not shown), the base lift device 120, a litter lift device 162, and a fowler section adjustment device 166. To this end, in some versions, the base 110 employs a base energy storage device 168B and the litter 112 employs a litter energy storage device 168L (collectively referred to herein as “energy storage device 168”). Other powered devices PD are also contemplated.

The powered devices PD may have many possible configurations for performing the predetermined functions of the patient transport apparatus 102. As will be appreciated from the subsequent description below, powered devices PD may cooperate with or otherwise form a part of the patient transport apparatus 102 in certain versions. Exemplary configurations of some of the powered devices PD are described in greater detail below. One or more actuators may be used to effectuate functions of each powered device PD. It should be understood that numerous configurations of the powered devices PD, other than those specifically described herein, are contemplated. Exemplary scenarios of how certain powered devices PD may be utilized are also described below. However, numerous other scenarios not described herein are also contemplated.

The litter 112 of the present disclosure is configured to be removably attached to the intermediate frame 118 of the base 110, as noted above and as is described in greater detail below, and is generally operable between: an undocked mode MU (see FIG. 1A) where the litter 112 supports the patient for movement independent of the base 110, and a docked mode MD (see FIG. 1B) where the litter 112 support the patient for movement concurrent with the base 110. The process of moving between the undocked mode MU and the docked mode MD is described in U.S. Provisional Patent Application No. 63/237,304, entitled “Patient Transport Apparatus Base with Trolley for Docking Removable Litter”, filed on Aug. 26, 2021, which is hereby incorporated herein by reference in its entirety.

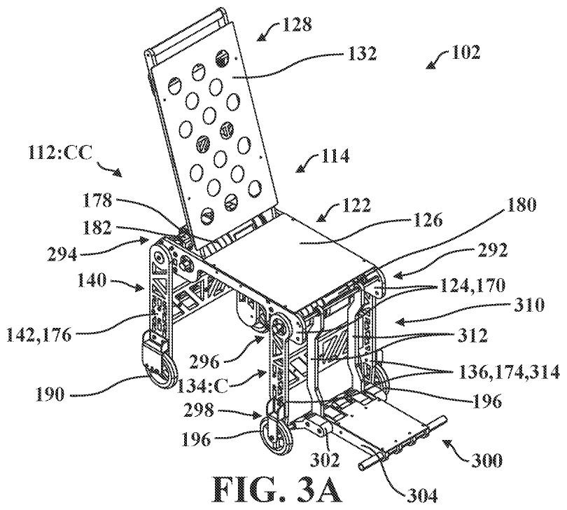

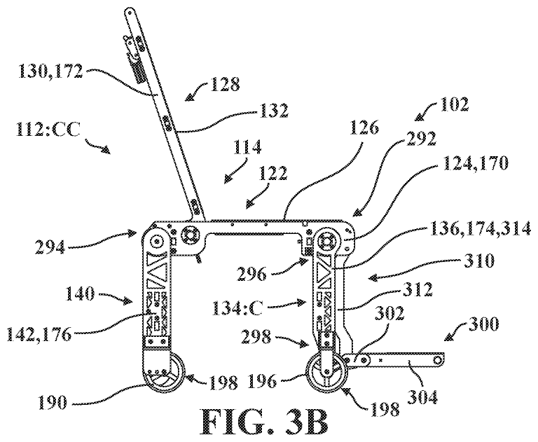

In the version shown in FIGS. 3A-3B, when operating in the chair configuration CC, the litter 112 is configured to serve as a mobile chair to transport the patient along floor surfaces FS. Mobile chairs (sometimes called “stair chairs” or “evacuation chairs”) are used to evacuate patients from buildings where patient accessibility is limited, such as buildings having more than one floor. As noted above, the patient support surface 114 of the litter 112 of the illustrated patient transport apparatus 102 is generally defined by the fowler section 132 and the seat section 126. Here, the seat section 126 is supported by the seat frame 124, and the fowler section 132 is supported by the fowler frame 130 that is coupled to the seat frame 124 such that the fowler frame 130 may pivot or otherwise articulate relative to the seat frame 124. The front frame 136 which is coupled to the seat frame 124 such that the front frame 136 may pivot or otherwise articulate relative to the seat frame 124, and the rear assembly 140 is coupled to the seat frame 124 such that the rear frame 142 may pivot or otherwise articulate relative to the seat frame 124.

In some configurations, the seat frame 124 may include seat frame members 170 spaced laterally apart from and fixed relative to each other. Similarly, the fowler frame 130 may include fowler frame members 172 spaced laterally apart and fixed relative to each other. The front frame 136 may include front legs 174 spaced laterally apart and fixed relative to each other, and the rear frame 142 may include rear legs 176 spaced laterally apart and fixed relative to each other. In the illustrated version, the litter 112 comprises a fowler actuator 178, a front actuator 180, and a rear actuator 182 which are each driven by the controller 156 (e.g., by the litter controller 156L) and are operatively attached to the seat assembly 122 to facilitate respectively pivoting or otherwise articulating the fowler assembly 128, the front assembly 134, and the rear assembly 140 relative to the seat assembly 122.

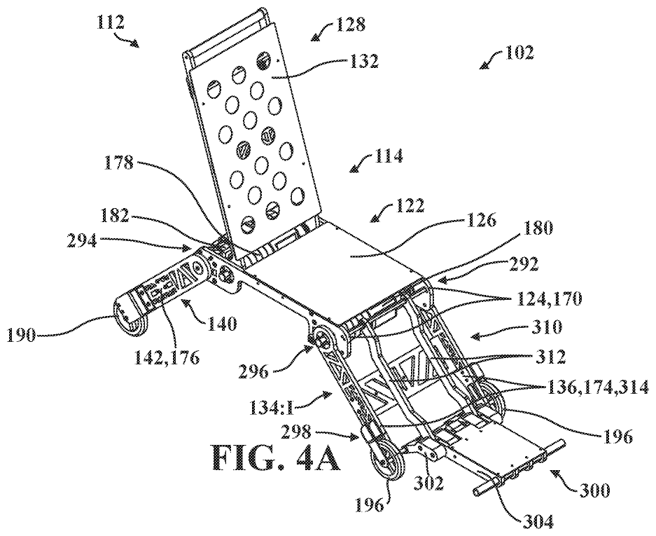

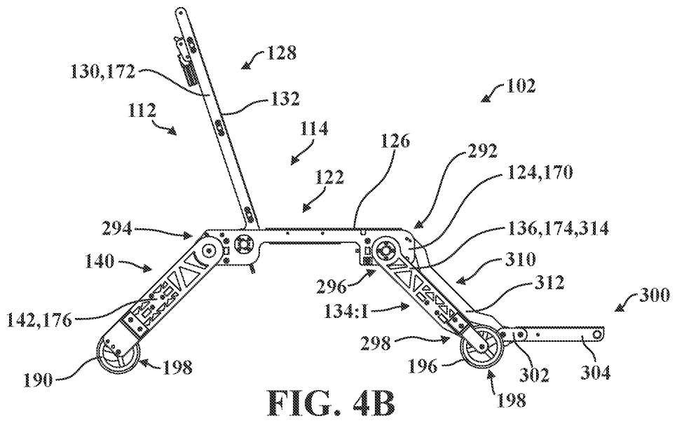

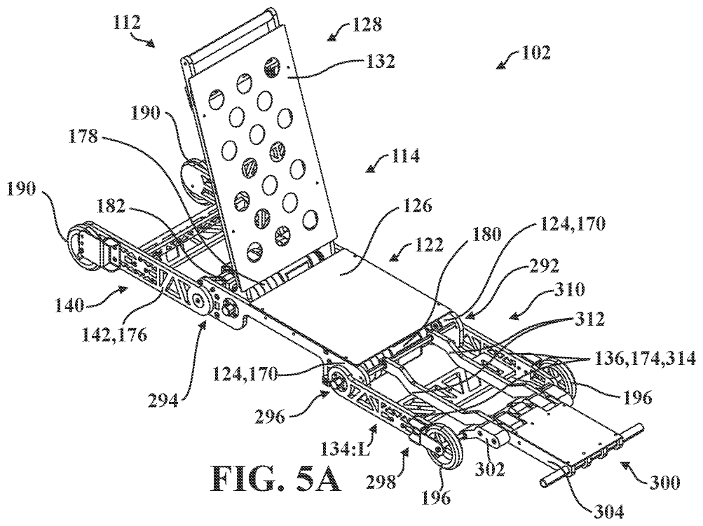

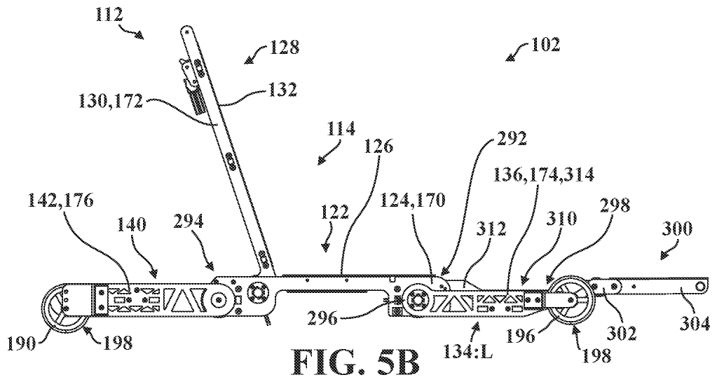

In the illustrated versions, the fowler assembly 128 is movable via the fowler actuator 178 between a fowler raised position 128R (see FIGS. 1A), a fowler lowered position 128L (see FIG. 1), and one or more intermediate fowler positions between the fowler raised position 128R and the fowler lowered position 128L. The rear assembly 140 also includes rear wheels 190 rotatably coupled to the rear legs 176 that are configured to be disposed in contact with the floor surface FS, such as to support the litter 112 for movement in the chair configuration CC. In the illustrated versions, the rear wheels 190 are freely rotatable. In alternative versions, the rear wheels 190 may be powered drive wheels coupled to the controller 156. Other configurations are contemplated. As described in U.S. Provisional Patent Application No. 63/237,301, entitled “Patient Transport Apparatus with Base Stabilizers for Loading and Unloading Removable Litters”, filed on Aug. 26, 2021 and U.S. Provisional Patent Application No. 63/237,304, entitled “Patient Transport Apparatus Base with Trolley for Docking Removable Litter”, filed on Aug. 26, 2021, the disclosures of which are hereby incorporated herein by reference in their entirety, the rear assembly 140 is movable via the rear actuator 182 between a rear assembly loft position 140L (shown in FIGS. 5A and 5B), a rear assembly chair position 140C (shown in FIGS. 3A and 3B), a rear assembly stair position (not shown), a rear assembly dock position 140D (shown in FIG. 1i), and one or more intermediate rear assembly positions 1401 (shown in FIGS. 4A and 4B) between the rear assembly loft position 140L and the rear assembly dock position 140D.

In some configurations, the rear assembly 140 may also include a ski assembly (not shown), as described in U.S. Provisional Patent Application No. 63/237,307, entitled “Patient Transport Apparatus with Ski Assemblies”, filed on Aug. 26, 2021, which is hereby incorporated herein by reference in its entirety.

The front legs 174 of the front assembly 134 support respective front wheels 196 at a bottom end 298 of the front assembly 134, which are realized as part of respective front caster assemblies 198 arranged to facilitate movement of the litter 112 in the chair configuration CC. In the illustrated versions, the front wheels 196 are freely rotatable, but could be motorized, braked, and the like in some versions. As described in U.S. Provisional Patent Application No. 63/237,301, entitled “Patient Transport Apparatus with Base Stabilizers for Loading and Unloading Removable Litters”, filed on Aug. 26, 2021 and U.S. Provisional Patent Application No. 63/237,304, entitled “Patient Transport Apparatus Base with Trolley for Docking Removable Litter”, filed on Aug. 26, 2021, which are hereby incorporated herein by reference in their entirety, the front assembly 134 is movable via the front actuator 180 between a front assembly loft position 134L (shown in FIGS. 5A and 5B), a front assembly chair position 134C (shown in FIGS. 3A and 3B), a front assembly stair position (not shown), and one or more intermediate front assembly positions 1341 (shown in FIGS. 4A and 4B) between the front assembly loft position 134L and the front assembly dock position 134D.

The litter lift device 162 is coupled to the litter 112 and is configured to raise and lower the patient between minimum and maximum heights of the litter 112, and to generally facilitate movement between the loft configuration CL, the chair configuration CC, and the stair configuration CS when the litter 112 is separated from the base 110. To this end, the illustrated litter lift device 162 generally includes the front actuator 180 and the rear actuator 182. The base lift device 120 is coupled to the base 110 and is configured to raise and lower the patient between a plurality of vertical configurations including a maximum raised configuration 110R (see FIG. 1i), a maximum lowered configuration 110L (see FIG. 1A), and a plurality of vertical configurations therebetween, both while the litter 112 is supported by the base 110 and, in some versions, while the litter 112 is undocked from the base 110.

In the representative version illustrated in FIGS. 1A-1B, the base 110 comprises one or more lift arms 202 coupling the intermediate frame 118 to the base frame 116. The base lift device 120 comprises one or more base lift actuators f coupled to at least one of the base frame 116 and the intermediate frame 118 to raise and lower the intermediate frame 118 and litter 112 relative to the floor surface FS and the base frame 116. The base lift device 120 may be configured to operate in the same manner or a similar manner as the lift mechanisms shown in U.S. Pat. Nos. 7,398,571, 9,486,373, 9,510,981, and/or U.S. Patent Application Publication No. 2018/0028383, previously referenced.

The base 110 of the patient transport apparatus 102 also generally includes a docking subassembly 206 operatively coupled to the intermediate frame 118 as described in U.S. Provisional Patent Application No. 63/237,304, entitled “Patient Transport Apparatus Base with Trolley for Docking Removable Litter”, filed on Aug. 26, 2021, which is hereby incorporated herein by reference in its entirety.

In the illustrated version, the base 110 also includes a stabilizer 224 operatively attached to the foot end FE of the intermediate frame 118 and configured for movement between a retracted configuration 224R (see FIG. 1B) where the stabilizer 224 is disposed in spaced relation from the floor surface FS, and a deployed configuration 224D (see FIG. 1A) where the stabilizer 224 engages the floor surface to brace the base 110 at an additional point of contact with the floor surface FS to stabilize the base 110, as described in U.S. Provisional Patent Application No. 63/237,301, entitled “Patient Transport Apparatus with Base Stabilizers for Loading and Unloading Removable Litters”, filed on Aug. 26, 2021, which is hereby incorporated herein by reference in its entirety.

Referring now to FIGS. 3A-6, the seat assembly 122 includes a front end 292 and a rear end 294. The front assembly 134 includes a top end 296 and a bottom end 298. The top end 296 of the front assembly 134 is operatively attached to the front end 292 of the seat assembly 122. As discussed above, the front assembly 134 pivots relative to the seat assembly 122 about a front axis XF and is movable between a front assembly chair position 134C (shown in FIGS. 3A and 3B), a front assembly loft position 134L (shown in FIGS. 5A and 5B), and one or more intermediate front assembly positions 1341 (shown in FIGS. 4A and 4B) between the front assembly loft position 134L and the front assembly dock position 134D. Also as discussed above, the front assembly 134 includes at least one wheel 196 operatively attached to the bottom end 298 of the front assembly 134.

With continued reference to FIGS. 3A-6, the patient support apparatus further includes a footrest assembly 300. The footrest assembly 300 includes a footrest mount 302 operatively attached to the bottom end 298 of the front assembly 134. The footrest mount 302 may extend between an upper mounting end 302U and a lower mounting end 302L, which are discussed in further detail below. The footrest assembly 300 also includes a footrest frame 304 having a footrest front end 306 and a footrest back end 308. The footrest back end 308 is operatively attached to the footrest mount 302. The footrest assembly 300 further includes a linkage assembly 310. The linkage assembly 310 extends between the seat assembly 122 and the footrest mount 302 to coordinate movement of the footrest mount 302 relative to the seat assembly 122 as the front assembly 134 moves between the plurality of front assembly positions.

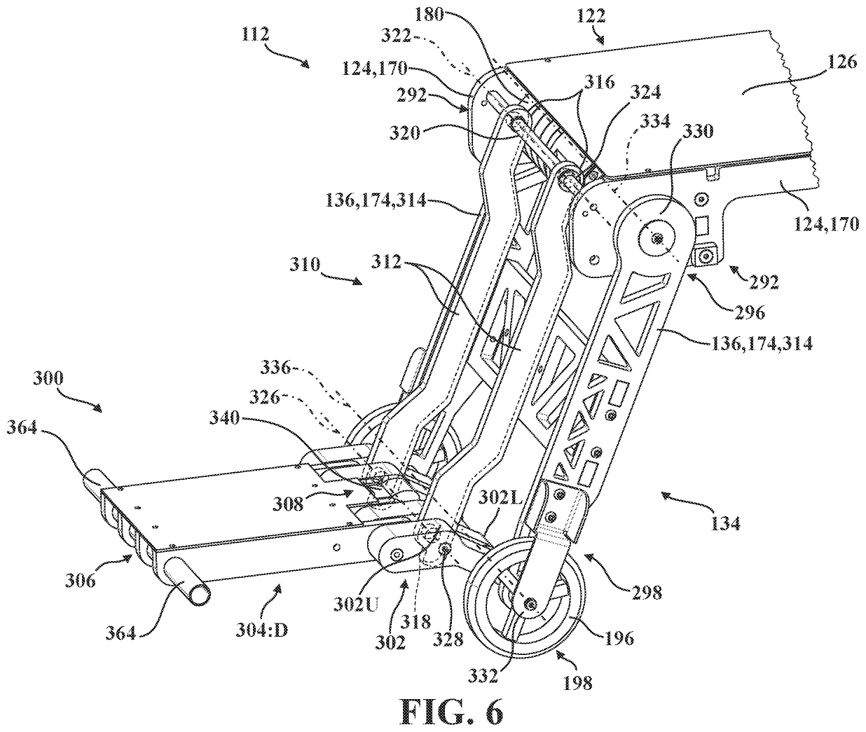

As best shown in FIG. 6, the linkage assembly 310 may include a four-bar linkage assembly having a first pair of links 312 and a second pair of links 314. The first pair of links 312 and the second pair of links 314 extend between the front end 292 of the seat assembly 122 and the footrest mount 302. Accordingly, the first pair of links 312 and the second pair of links 314 are arranged to guide the footrest mount 302 along a pre-determined motion profile as the front assembly 134 moves between the plurality of front assembly positions.

With continued reference to FIG. 6, the first pair of links 312 may each extend between a first mounting end 316 and a second mounting end 318. The first mounting end 316 of each of the first pair of links 312 is coupled to a linkage mounting member 320 for pivoting movements. The linkage mounting member 320 is coupled to the front end 292 of the seat assembly and defines a first upper linkage pivot axis 322. In some configurations, the linkage mounting member 320 extends between the seat frame members 170. Accordingly, the first pair of links 312 are configured to pivot about the first upper linkage pivot axis 322. In some configurations, the first pair of links 312 may be coupled to the linkage mounting member 320 using bushings 324. However, other suitable members for coupling the first pair of links 312 to the linkage mounting member 320 are contemplated.

Additionally, the footrest mount 302 may define a first lower linkage pivot axis 326. The second mounting end 318 of each of the first pair of links 312 are coupled to the footrest mount 302. For example, the second mounting end 318 may be coupled to the upper mounting end 302U of the footrest mount 302. Accordingly, the first pair of links 312 are also configured to pivot about the first lower linkage pivot axis 326. In some configurations, the first pair of links 312 may be coupled to the upper mounting end 302U of the footrest mount 302 by an upper footrest pivot dowel 328 extending along the upper mounting end 302U of the footrest mount 302. However, other arrangements for coupling the first pair of links 312 to the upper mounting end 302U of the footrest mount 302 are contemplated.

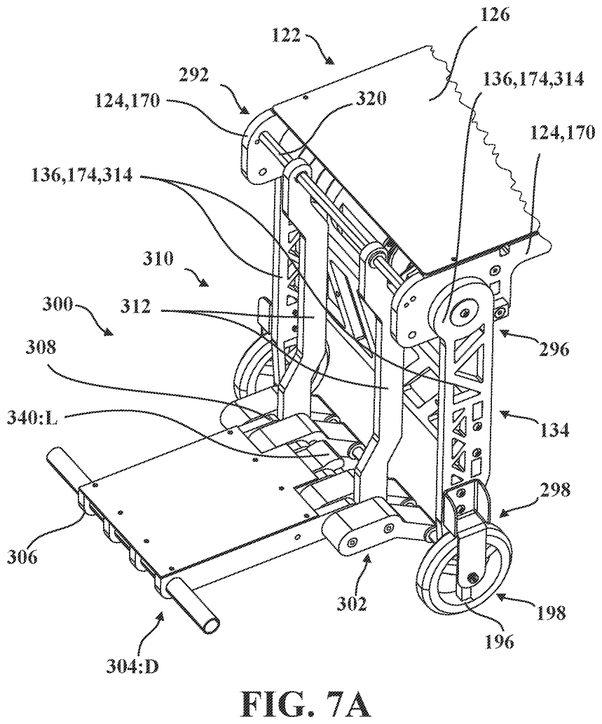

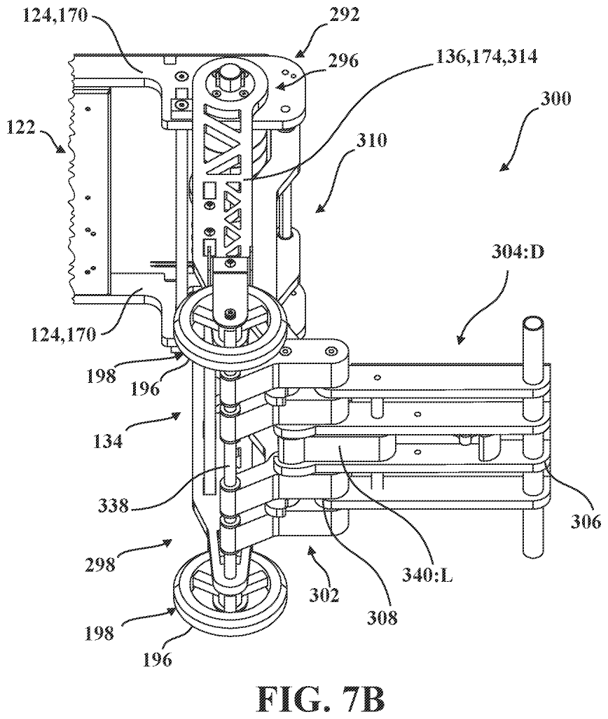

The second pair of links 314 may be defined by the front frame 136 of the front assembly 134. As mentioned above, the front assembly 134 may include front legs 174 spaced apart from each other. Accordingly, the front legs 174 may define the second pair of links 314. The front legs 174 may extend between a first front leg mounting end 330 (corresponding with the top end 296 of the front assembly 134) and a second front leg mounting end 332 (corresponding with the bottom end 298 of the front assembly 134). The first front leg mounting end 330 is coupled to the front end 292 of the seat assembly 122 for pivoting movement for the front assembly 134 relative to the seat assembly 122, as described above. Accordingly, the second pair of links 314 may pivot about a second upper linkage pivot axis 334. In some configurations, the second upper linkage pivot axis 334 may be co-axial with the front axis XF. The second front leg mounting end 332 is coupled to the lower mounting end 302L of the footrest mount 302. Accordingly, the second pair of links 314 may also pivot about a second lower linkage pivot axis 336. In some configurations, the second pair of links 314 may be coupled to the lower mounting end 302L of the footrest mount 302 by a lower footrest pivot dowel 338 (best shown in FIGS. 7A-9B) extending along the lower mounting end 302L of the footrest mount 302. However, other suitable members for coupling the second pair of links 314 to the lower mounting end 302L of the footrest mount 302 are contemplated.

Referring to FIGS. 3A-5B, the first pair of links 312 and the second pair of links 314 of the linkage assembly 310 coordinate movement of the footrest mount 302 relative to the seat assembly 122 as the front assembly 134 moves between the plurality of front assembly positions. For example, FIGS. 3A and 3B show the litter 112 in the chair configuration CC. In the chair configuration CC, the front assembly 134 is in the chair position 134C such that the front assembly 134 is substantially perpendicular to the seat assembly 122 and the footrest mount 302 is substantially parallel to the seat assembly 122 such that the footrest frame 304 is also substantially parallel to the seat assembly 122. Accordingly, the footrest assembly 300 is arranged below the seat assembly 122 to support feet of a patient feet in a seated position. Referring to FIGS. 4A and 4B, when the front assembly 134 moves to an intermediate position 1341, the linkage assembly 310 coordinates movement of the footrest mount 302 such that the footrest mount 302 remains substantially parallel to the seat assembly 122 such that the footrest frame 304 also remains substantially parallel to the seat assembly 134. Further, referring to FIGS. 5A and 5B, when the front assembly 134 moves to the front assembly loft position 134L, the front assembly 134 is arranged substantially parallel to the seat assembly 122, and the linkage assembly 310 continues to coordinate movement of the footrest mount 302 such that the footrest mount 302 remains substantially parallel to the seat assembly 122 such that the footrest frame 304 also remains substantially parallel to the seat assembly 134. Accordingly, the footrest assembly 300 is arranged in vertical proximity to the seat assembly 122 to support at least one leg of a patient when a patient is lying on the litter 112 in the loft configuration CL.

The footrest assembly 300 may further include a bar 364. The bar 364 may extend laterally from the footrest frame 304. FIG. 6 shows the bar 364 extending laterally from both sides of the footrest frame 304. However, it should be appreciated that the bar 364 may extend from just one side of the footrest frame 304. In some configurations, the bar 364 may define one or more handles arranged for facilitating a user moving the patient transport apparatus 102. In some configurations, the bar 364 may define one or more stirrups for supporting feet of a patient. In the configuration shown in FIG. 6, the bar 364 may serve as both a handle and stirrups.

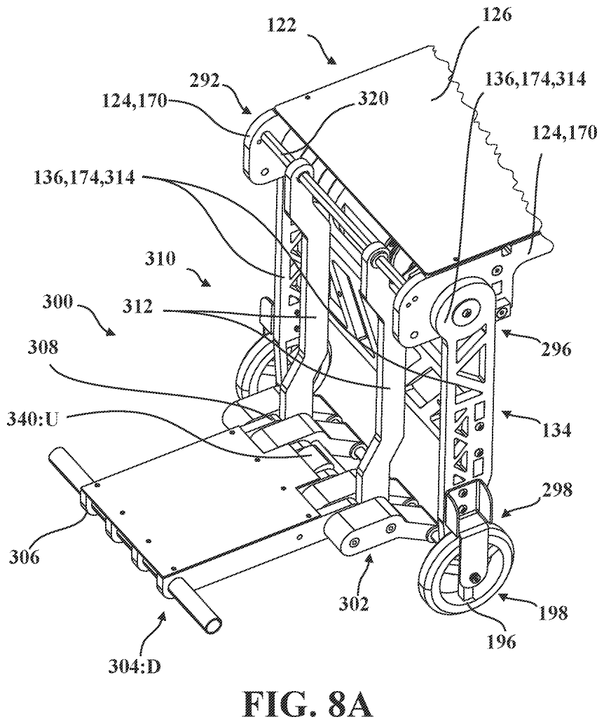

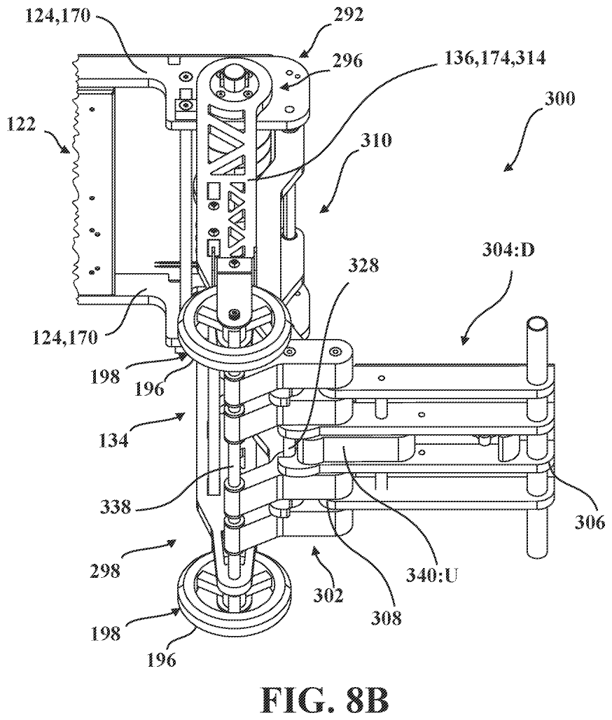

Referring to FIGS. 7A-9B, the footrest frame 304 may be configured for movement relative to the footrest mount 302. In some configurations, the footrest frame 304 is coupled to the footrest mount 302 for pivoting movement. The footrest frame 304 may move between a plurality of footrest frame positions including a footrest deployed position 304D and a footrest stowed position 304S. In the footrest deployed position 304D (shown in FIGS. 7A-8B), the footrest frame 304 is arranged to support feet of a patient. For example, the footrest frame 304 may be arranged substantially perpendicular to the front assembly 134 to provide a platform to support the feet of a patient. In the footrest stowed position 304S, the footrest frame 304 may be arranged substantially parallel to the front assembly 134.

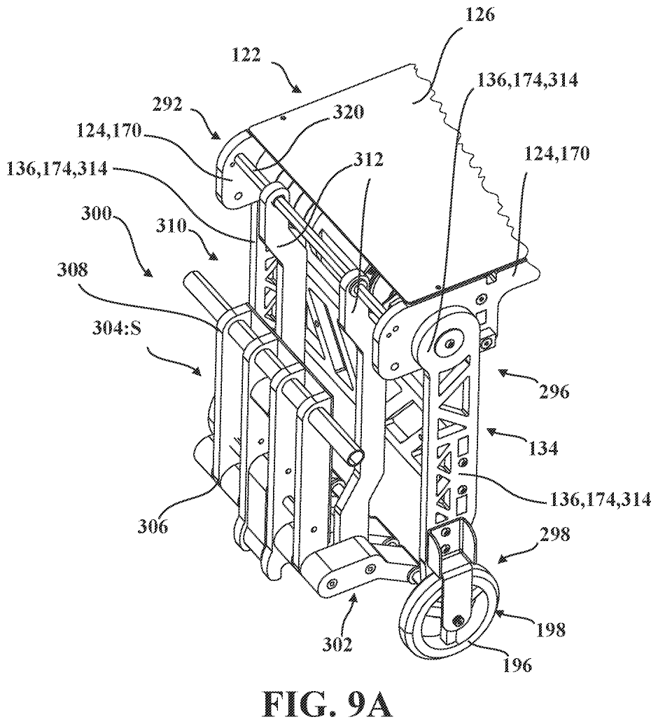

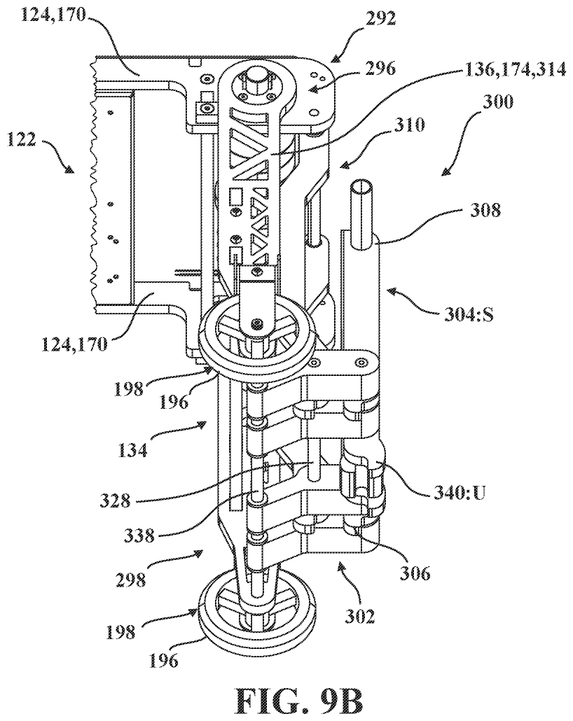

With continued reference to FIGS. 7A-9B, the footrest assembly 300 may further comprise a locking member 340. The locking member 340 is configured to move between a locked state 340L and an unlocked state 340U. It will be appreciated that various configurations of the locking member 340 to selectively limit movement of the footrest frame 304 relative to the footrest mount 302 is contemplated. In some configurations, the locking member 340 is operatively attached to the footrest frame 304. In the locked state 340L, the locking member 340 engages the footrest mount 302 to limit movement of the footrest frame 304 relative to the footrest mount 302. In the unlocked state 340U, the locking member 340 is spaced from the footrest mount 302 to permit movement of the footrest frame 304 relative to the footrest mount 302. In some configurations, the lock member 340 may operate in the locked state 340L to retain the footrest frame 304 in the stowed position 304S, while in other configurations, the lock member 340 may operate in the locked state 340L to retain the footrest frame in the deployed position 340D. FIGS. 7A and 7B show the locking member 340 in the locked state 340L such that the locking member 340 engages the footrest mount 302 to limit movement of the footrest frame 304 relative to the footrest mount 302. FIGS. 8A and 8B show the lock member 340 moves to the unlocked state 340U such that the locking member 340 is spaced from the footrest mount 302, thereby allowing the footrest frame 304 to pivot relative to the footrest mount 302. FIGS. 9A and 9B show the footrest frame 304 moved to the stowed position 304S while the lock member 340 is in the unlocked state 340U. The footrest assembly 300 may further include a lock biasing member (not shown) to urge the lock member 340 toward the locked state 340L.

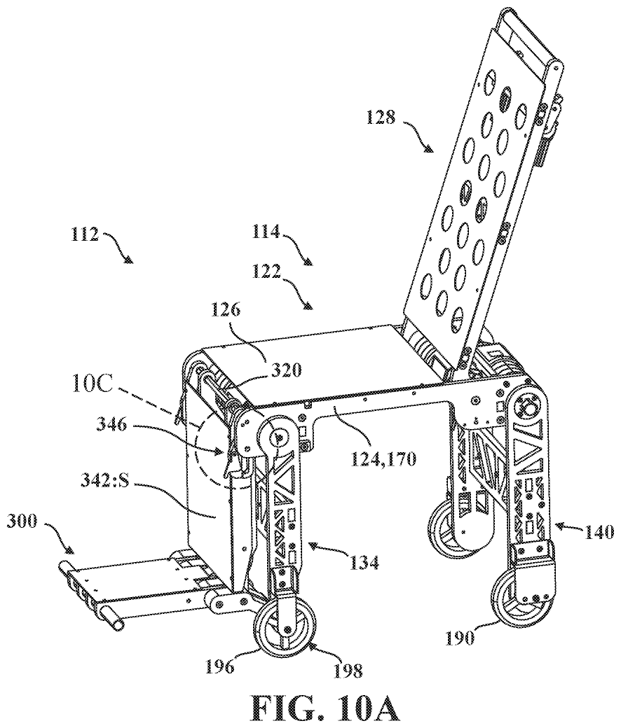

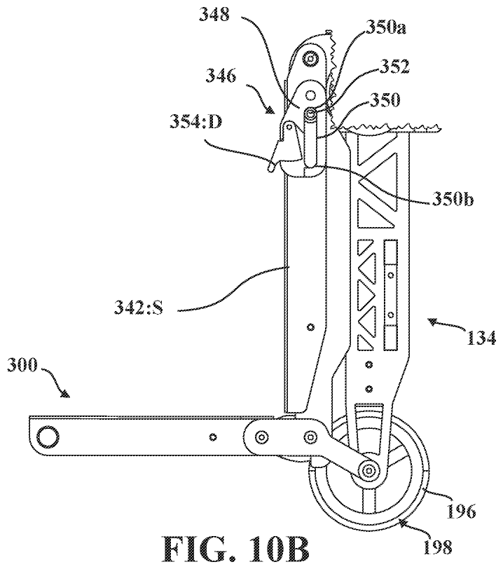

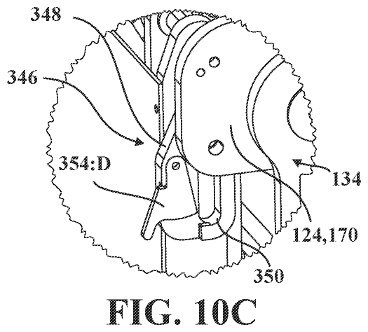

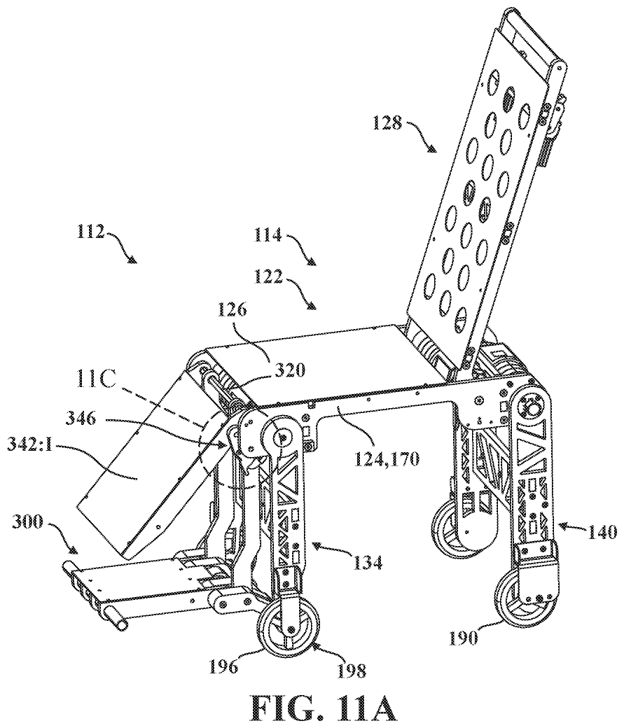

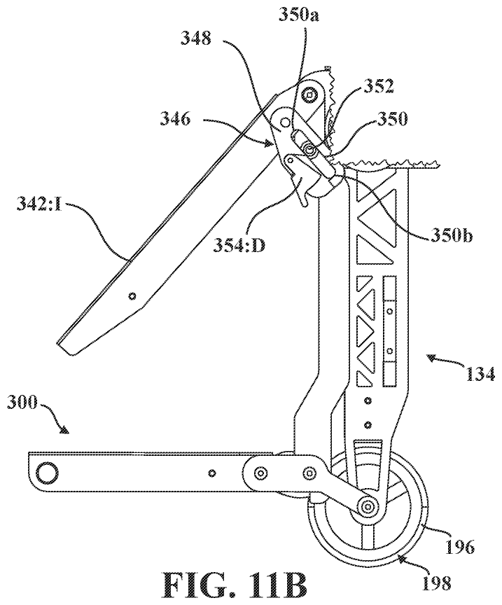

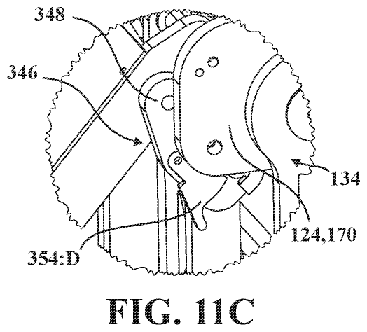

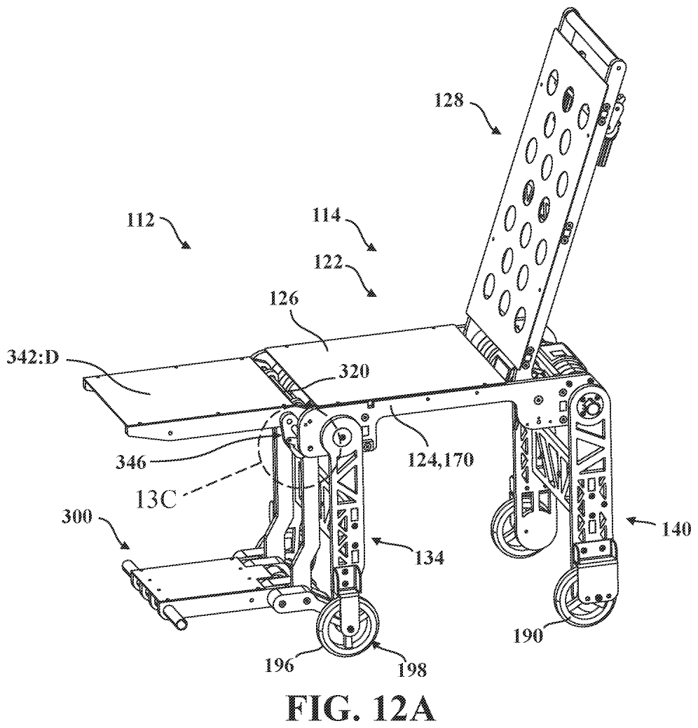

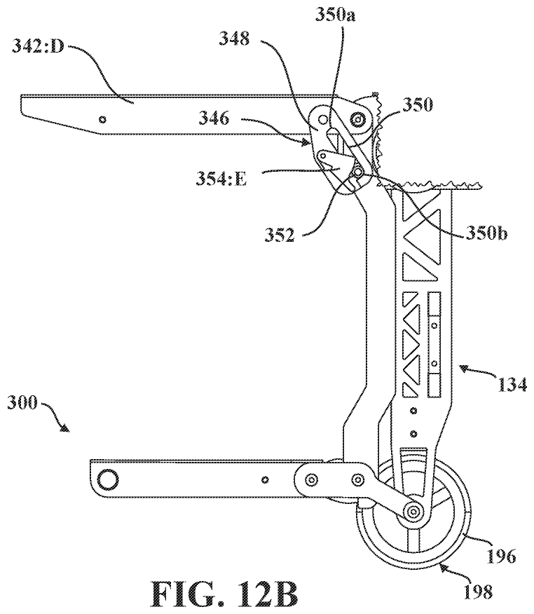

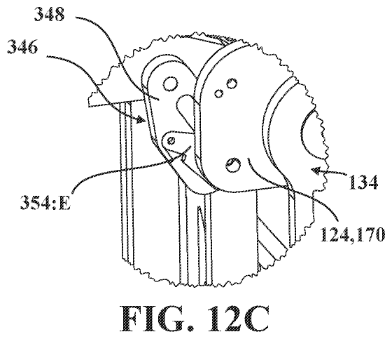

Referring now to FIGS. 10A-12C, the patient support apparatus 102 may further include a leg support 342. The leg support 342 may be arranged about the litter 112 for pivoting movement about a support axis (in some configurations, the support axis may be the same as the first upper linkage pivot axis 322). The leg support 342 may be arranged adjacent to the front end 292 of the seat assembly 122. For example, in some configurations, the leg support 342 is coupled to the linkage mounting member 320 for pivoting movement about the first upper linkage pivot axis 322. The leg support 342 is configured for movement between a plurality of leg support positions including a leg support deployed position 342D and a leg support stowed position 342S. In the leg support deployed position 342D (shown in FIGS. 10A-10C), the leg support 342 is substantially parallel with the seat assembly 122 to support at least one leg of a patient in an elevated position. In the leg support stowed position 342S, (shown in FIGS. 12A-12C), the leg support 342 is substantially parallel to the front assembly 134 so as to not obstruct a patient's leg and define a portion of the patient support surface 114 for supporting the patient on the litter 112. FIGS. 11A-11C show the leg support 342 in an intermediate position 3421 as the leg support 342 moved between the stowed position 342S and the deployed position 342D.

With continued reference to FIGS. 10A-12C, the patient support apparatus 102 may further include a latch 346. The latch 346 is arranged for selectively retaining the leg support 342 in the leg support deployed position 342D (shown in FIGS. 12A-12C). It will be appreciated that various types of mechanisms for retaining the leg support 342 in the leg support deployed position 342D are contemplated. For example, in the configuration shown in FIGS. 10A-12C, the latch 346 includes a body 348 pivotably attached to the front assembly 134. The body 348 defines a slot 350 extending between a first end 350a and second end 350b. The slot 350 is configured to receive a dowel 352 extending from the leg support 342. As the leg support 342 moves between the stowed position 342S and the deployed position 342D, the dowel 352 moves along the slot 350 from the first end 350a (shown in FIGS. 10A-10C) to the second end 350b (shown in FIGS. 12A-12C). The latch 346 may further include a toggle member 354 configured to move between an engaged state 354E and a disengaged state 354D. FIGS. 10A-11C show the toggle member 354 in the disengaged state 354D. FIGS. 12A-12C show the toggle member 354 in the engaged state 354E. When the toggle member 354 is in the engaged state 354E and the leg support 342 is in the deployed position 342D, the toggle member 354 abuts the dowel 352 to retain the leg support 342 is in the deployed position 342D. In some configurations, the toggle member 354 may be biased toward the engaged state 354E by a biasing member (not shown).

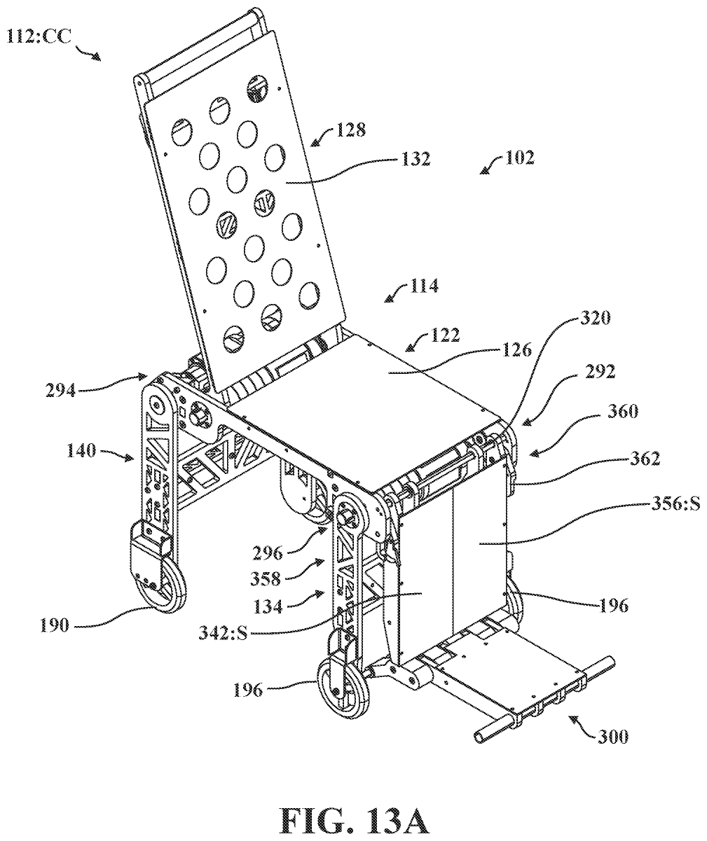

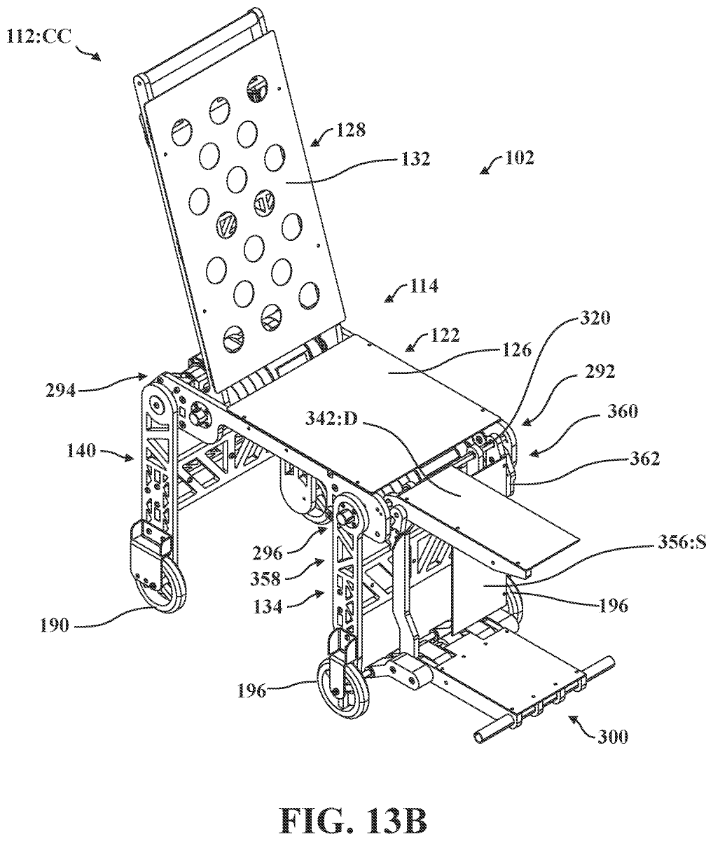

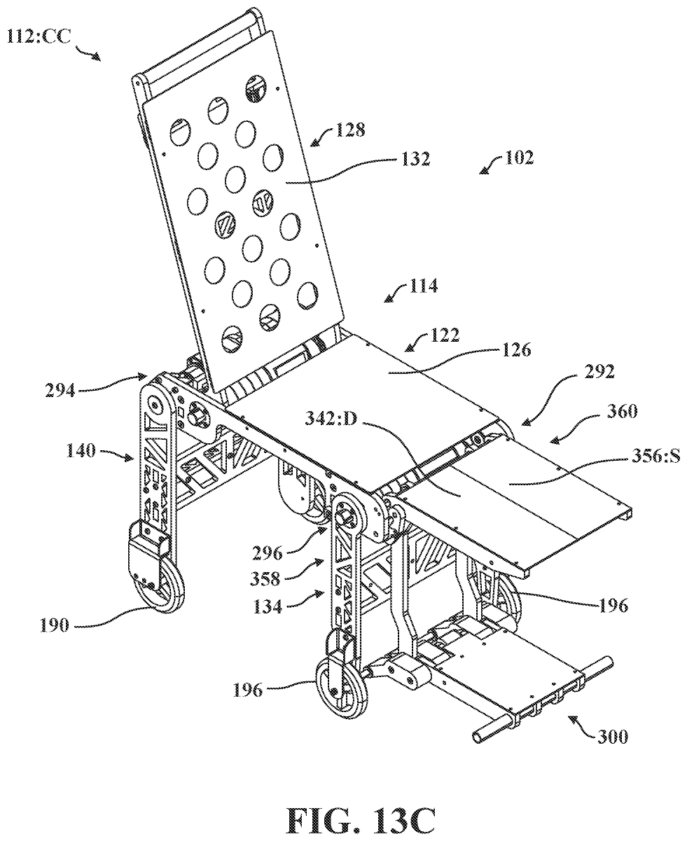

Referring now to FIGS. 13A-13C, the leg support 342 may be a first leg support 342 and the litter 112 may further include a second leg support 356. The first leg support 342 may be arranged on a first lateral side 358 of the patient support apparatus 102 and the second leg support 356 may be arranged on a second lateral side 360 of the patient support apparatus 102, opposite the first lateral side 358. Here, similar to the first leg support 342, the second leg support 356 may be arranged adjacent to the front end 292 of the seat assembly 122. For example, in some configuration, the second leg support 356 is coupled to the linkage mounting member 320 for pivoting movement about the first upper linkage pivot axis 322. The second leg support 356 is configured for movement between a plurality of second leg support positions including a second leg support deployed position 356D and a second leg support stowed position 356S. In the second leg support deployed position 356D (shown in FIG. 13C), the second leg support 356 is substantially parallel with the seat assembly 122 to support a leg of a patient in an elevated position. In the second leg support stowed position 356S, (shown in FIGS. 13A and 13B), the second leg support 356 is substantially parallel to the front assembly 134 so as to not obstruct a patient's leg and define a portion of the patient support surface 114 for supporting the patient on the litter 112.

With continued reference to FIGS. 13A-13C, first leg support 342 and second leg support 356 may be configured to be moved independently to selectively facilitate supporting each leg of a patient. Additionally, the patient support apparatus 102 may further include a second latch 362. The second latch 362 is arranged for selectively retaining the second leg support 356 in the second leg support deployed position 356D. Any suitable mechanism for retaining the second leg support 356 in the leg support deployed position 356D is contemplated, such as the configuration of the first latch 346 described above.

It will be further appreciated that the terms “include,” “includes,” and “including” have the same meaning as the terms “comprise,” “comprises,” and “comprising.” Moreover, it will be appreciated that terms such as “first,” “second,” “third,” and the like are used herein to differentiate certain structural features and components for the non-limiting, illustrative purposes of clarity and consistency.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient support apparatus comprising:
a seat assembly having a front end and a rear end;
a front assembly having a bottom end including a wheel for contacting a ground surface and a top end operatively attached to the front end of the seat assembly, the front assembly configured for movement between a plurality of front assembly positions including a front assembly chair position and a front assembly loft position; and
a footrest assembly, the footrest assembly comprising:
   a footrest mount operatively attached to the bottom end of the front assembly,
   a footrest frame having a footrest front end and a footrest back end operatively attached to the footrest mount, and
   a linkage assembly extending between the seat assembly and the footrest mount to coordinate movement of the footrest mount relative to the seat assembly as the front assembly moves between the plurality of front assembly positions.

II. A patient support apparatus comprising:
a seat assembly having a front end and a rear end;
a front assembly having a bottom end and a top end operatively attached to the front end of the seat assembly, the front assembly configured for movement between a plurality of front assembly positions including a front assembly chair position and a front assembly loft position; and
a footrest assembly, the footrest assembly comprising:
   a footrest mount operatively attached to the bottom end of the front assembly,
   a footrest frame operatively attached to the footrest mount and having a front end and a back end, the footrest frame configured for movement relative to the footrest mount between footrest frame positions including a footrest stowed position and a footrest deployed position, and
   a linkage assembly extending between the seat assembly and the footrest mount to coordinate movement of the footrest mount relative to the seat assembly as the front assembly moves between the plurality of front assembly positions.

III. The patient support apparatus of any of clauses I-II, wherein the linkage assembly further comprises a four-bar linkage assembly having a first pair of links and a second pair of links extending between the front end of the seat assembly and the footrest mount, the first pair of links and the second pair of links arranged to guide the footrest mount along a pre-determined motion profile as the front assembly moves between the plurality of front assembly positions.

IV. The patient support apparatus of clause III, wherein the first pair of links each extend between a first mounting end and a second mounting end, wherein:
the first mounting end is coupled to a linkage mounting member operatively attached to the front end of the seat assembly and defining a first upper linkage pivot axis, and
the second mounting end is coupled to an upper mounting end of the footrest mount.

V. The patient support apparatus of any of clauses III-IV, wherein the second pair of links are defined by a front frame of the front assembly, the front frame comprising a pair of front legs each extend between a first front leg mounting end and a second front leg mounting end, wherein:
the first front leg mounting end is coupled to the front end of the seat assembly, and
the second front leg mounting end is coupled to a lower mounting end of the footrest mount.

VI. The patient support apparatus of any of clauses I-V, wherein the footrest frame is configured for movement relative to the footrest mount between a plurality of footrest frame positions including:
a footrest deployed position where the footrest frame is arranged to support feet of a patient, and
a footrest stowed position where the footrest frame is substantially parallel to the front assembly.

VII. The patient support apparatus of clause VI, wherein the footrest assembly further comprises a lock member operatively attached to the footrest frame and configured to move between:
a locked state where the lock member engages the footrest mount to limit movement of the footrest frame relative to the footrest mount,
and an unlocked state where the lock member is spaced from the footrest mount to permit movement of the footrest frame relative to the footrest mount.

VIII. The patient support apparatus of any of clauses I-VII, further comprising a leg support arranged for pivoting movement about a support axis disposed adjacent to the front end of the seat assembly between a plurality of leg support positions including:
a leg support deployed position where the leg support is substantially parallel with the seat assembly to support at least one leg of a patient in an elevated position, and
a leg support stowed position where the leg support is substantially parallel with the front assembly.

IX. The patient support apparatus of clause VIII, further comprising a first latch for selectively retaining the leg support in the leg support deployed position.

X. The patient support apparatus of any of clauses VIII-IX, wherein:
the leg support is a first leg support and arranged on a first lateral side of the patient support apparatus, and
the patient support apparatus further comprises a second leg support arranged for pivoting movement about the support axis between a plurality of leg support positions including:
   a second leg support deployed position where the second leg support is substantially parallel with the seat assembly to support a leg of a patient in an elevated position, and
   a second leg support stowed position where the second leg support is substantially parallel with the front assembly.

XI. The patient support apparatus of clause X, wherein the first and second leg supports are configured to be moved independently to selectively facilitate supporting each leg of a patient.

XII. The patient support apparatus of any of clauses X-XI, further comprising a second latch for selectively retaining the second leg support in the second leg support deployed position.

XIII. The patient support apparatus of any of clauses I-XII, wherein the footrest assembly further comprises a bar extending laterally from the footrest front end to define a handle arranged for facilitating a user moving the patient support apparatus.

XIV. The patient support apparatus of any of clauses I-XIII, wherein the footrest assembly further comprises a bar extending laterally from the footrest front end to define a stirrup arranged for supporting feet of a patient.

XV. The patient support apparatus of any of clauses I-XIV, wherein the front assembly is arranged substantially perpendicular to the seat assembly when the front assembly is in the front assembly chair position such that the footrest assembly is arranged below the seat assembly to support feet of a patient feet in a seated position.

XVI. The patient support apparatus of any of clauses I-XV, wherein the front assembly is arranged substantially parallel to the seat assembly when the front assembly is in the front assembly loft position such that the footrest assembly is arranged in vertical proximity to the seat assembly to support at least one leg of a patient.

XVII. The patient support apparatus of any of clauses I-XVI, further comprising a front actuator arranged to articulate the front assembly relative to the seat assembly between the front assembly chair position and the front assembly loft position.

XVIII. The patient support apparatus of any of clauses I-XVII, further comprising a rear assembly coupled to the rear end of the seat assembly and configured for movement between a plurality of rear assembly positions including a rear assembly chair position and a rear assembly loft position.

XIX. The patient support apparatus of clause XVIII, further comprising a rear actuator arranged to articulate the rear assembly relative to the seat assembly between the rear assembly chair position and the rear assembly loft position.

XX. The patient support apparatus of any of clauses I-XIX, further comprising a fowler assembly coupled to the rear end of the seat assembly and arranged for movement relative to the seat assembly.

XXI. The patient support apparatus of clause XX, further comprising a fowler actuator arranged to articulate the fowler assembly relative to the seat assembly.

1. A patient support apparatus comprising:
a seat assembly having a front end and a rear end;
a front assembly having a bottom end including a wheel for contacting a ground surface and a top end operatively attached to the front end of the seat assembly, the front assembly configured for movement between a plurality of front assembly positions including a front assembly chair position and a front assembly loft position; and
a footrest assembly, the footrest assembly comprising:
a footrest mount operatively attached to the bottom end of the front assembly,
a footrest frame having a footrest front end and a footrest back end operatively attached to the footrest mount, and
a linkage assembly extending between the seat assembly and the footrest mount to coordinate movement of the footrest mount relative to the seat assembly as the front assembly moves between the plurality of front assembly positions.

2. The patient support apparatus of claim 1, wherein the linkage assembly further comprises a four-bar linkage assembly having a first pair of links and a second pair of links extending between the front end of the seat assembly and the footrest mount, the first pair of links and the second pair of links arranged to guide the footrest mount along a pre-determined motion profile as the front assembly moves between the plurality of front assembly positions.

3. The patient support apparatus of claim 2, wherein the first pair of links each extend between a first mounting end and a second mounting end, wherein:
the first mounting end is coupled to a linkage mounting member operatively attached to the front end of the seat assembly and defining a first upper linkage pivot axis, and
the second mounting end is coupled to an upper mounting end of the footrest mount.

4. The patient support apparatus of claim 2, wherein the second pair of links are defined by a front frame of the front assembly, the front frame comprising a pair of front legs each extend between a first front leg mounting end and a second front leg mounting end, wherein:
the first front leg mounting end is coupled to the front end of the seat assembly, and
the second front leg mounting end is coupled to a lower mounting end of the footrest mount.

5. The patient support apparatus of claim 1, wherein the footrest frame is configured for movement relative to the footrest mount between a plurality of footrest frame positions including:
a footrest deployed position where the footrest frame is arranged to support feet of a patient, and
a footrest stowed position where the footrest frame is substantially parallel to the front assembly.

6. The patient support apparatus of claim 5, wherein the footrest assembly further comprises a lock member operatively attached to the footrest frame and configured to move between:
a locked state where the lock member engages the footrest mount to limit movement of the footrest frame relative to the footrest mount,
and an unlocked state where the lock member is spaced from the footrest mount to permit movement of the footrest frame relative to the footrest mount.

7. The patient support apparatus of claim 1, further comprising a leg support arranged for pivoting movement about a support axis disposed adjacent to the front end of the seat assembly between a plurality of leg support positions including:
a leg support deployed position where the leg support is substantially parallel with the seat assembly to support at least one leg of a patient in an elevated position, and
a leg support stowed position where the leg support is substantially parallel with the front assembly.

8. The patient support apparatus of claim 7, further comprising a first latch for selectively retaining the leg support in the leg support deployed position.

9. The patient support apparatus of claim 7, wherein:
the leg support is a first leg support and arranged on a first lateral side of the patient support apparatus, and
the patient support apparatus further comprises a second leg support arranged for pivoting movement about the support axis between a plurality of leg support positions including:
a second leg support deployed position where the second leg support is substantially parallel with the seat assembly to support a leg of a patient in an elevated position, and
a second leg support stowed position where the second leg support is substantially parallel with the front assembly.

10. The patient support apparatus of claim 9, wherein the first and second leg supports are configured to be moved independently to selectively facilitate supporting each leg of a patient.

11. The patient support apparatus of claim 9, further comprising a second latch for selectively retaining the second leg support in the second leg support deployed position.

12. The patient support apparatus of claim 1, wherein the footrest assembly further comprises a bar extending laterally from the footrest front end to define a handle arranged for facilitating a user moving the patient support apparatus.

13. The patient support apparatus of claim 1, wherein the footrest assembly further comprises a bar extending laterally from the footrest front end to define a stirrup arranged for supporting feet of a patient.

14. The patient support apparatus of claim 1, wherein the front assembly is arranged substantially perpendicular to the seat assembly when the front assembly is in the front assembly chair position such that the footrest assembly is arranged below the seat assembly to support feet of a patient feet in a seated position.

15. The patient support apparatus of claim 1, wherein the front assembly is arranged substantially parallel to the seat assembly when the front assembly is in the front assembly loft position such that the footrest assembly is arranged in vertical proximity to the seat assembly to support at least one leg of a patient.

16. The patient support apparatus of claim 1, further comprising a front actuator arranged to articulate the front assembly relative to the seat assembly between the front assembly chair position and the front assembly loft position.

17. The patient support apparatus of claim 1, further comprising a rear assembly coupled to the rear end of the seat assembly and configured for movement between a plurality of rear assembly positions including a rear assembly chair position and a rear assembly loft position.

18. The patient support apparatus of claim 17, further comprising a rear actuator arranged to articulate the rear assembly relative to the seat assembly between the rear assembly chair position and the rear assembly loft position.

19. The patient support apparatus of claim 1, further comprising a fowler assembly coupled to the rear end of the seat assembly and arranged for movement relative to the seat assembly.

20. The patient support apparatus of claim 19, further comprising a fowler actuator arranged to articulate the fowler assembly relative to the seat assembly.

21. (canceled)
